(19) United States
(12) Patent Application Publication
(10) Pub. No.: US 2010/0075028 A1
(43) Pub. Date: Mar. 25, 2010

(54) METHOD FOR PROTECTING ELEMENT OF ELECTRONIC PRODUCT

(76) Inventor: Chih-Hao HUANG, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/234,884

(22) Filed: Sep. 22, 2008

(51) Int. Cl. B05D 5/12

(52) U.S. Cl. 427/126.3; 427/58

(57) ABSTRACT

A method adapted for protecting elements of an electronic product from being thermally damaged in a secondary processing of the electronic product is described hereinafter. Firstly, make an inorganic oxide solution of nanometer by way of a sol-gel method. Secondly, coat the inorganic oxide solution of nanometer onto surfaces of the elements before the secondary processing of the electronic product. Lastly, subject the electronic product coated with the inorganic oxide solution of nanometer to a room temperature or a heating environment lower than 50 degrees centigrade to make the inorganic oxide solution of nanometer dry for forming nanometer protective films on the surfaces of the elements of the electronic product so as to protect the elements from being thermally damaged in the secondary processing of the electronic product.

### BACKGROUND OF THE INVENTION

1. Field of the Invention

The present invention generally relates to a method for protecting elements of an electronic product, and more particularly to a method for protecting elements of an electronic product in a secondary processing.

2. The Related Art

In the course of manufacturing an electronic product, some elements of the electronic product such as some transmission lines of information are usually unable to bear some specific environments in a secondary processing of the electronic product such as a high-temperature environment higher than 150 degrees centigrade. Traditionally, there are two methods for solving this problem. The first method is to isolate the elements by some additional isolating members before the secondary processing of the electronic product. However, the first method is complicated and the additional isolating members occupy a larger space in the electronic product, thus compromising installation of other components. The second method is to divide the secondary processing of the electronic product into many small processes for being operated separately. However, this causes the second method to be complex and therefore makes it almost impossible to apply the second method to various kinds of situations.

### SUMMARY OF THE INVENTION

An object of the present invention is to provide a method adapted for protecting elements of an electronic product from being thermally damaged in a secondary processing of the electronic product. The method is described hereinafter. Firstly, make an inorganic oxide solution of nanometer by way of a sol-gel method. Secondly, coat the inorganic oxide solution of nanometer onto surfaces of the elements before the secondary processing of the electronic product. Lastly, subject the electronic product coated with the inorganic oxide solution of nanometer to a room temperature or a heating environment lower than 50 degrees centigrade to make the inorganic oxide solution of nanometer dry for forming nanometer protective films on the surfaces of the elements of the electronic product so as to protect the elements from being thermally damaged in the secondary processing of the electronic product.

As described above, the above-mentioned method can effectively protect the elements of the electronic product from being thermally damaged in the secondary processing of the electronic product by forming the nanometer protective films on the surfaces of the elements before the secondary processing of the electronic product, wherein the nanometer protective film has a good adiabatic and insulating ability. Furthermore, the procedure of the above-mentioned method is relatively simple and the nanometer protective film is apt to be made so thinly that it occupies a smaller space in the electronic product.

### BRIEF DESCRIPTION OF THE DRAWINGS

The present invention will be apparent to those skilled in the art by reading the following description of a preferred embodiment thereof, with reference to the attached drawing, in which:

FIG. 1 is a cross-sectional view of an electronic product processed by a method for protecting elements of an electronic product in accordance with the present invention.

### DETAILED DESCRIPTION OF THE PREFERRED EMBODIMENT

A method adapted for protecting elements of an electronic product from being thermally damaged in a secondary processing of the electronic product is described hereinafter.

Firstly, an inorganic oxide solution of nanometer is prepared by way of a sol-gel method, wherein the inorganic oxide solution of nanometer can be any one of or several from a silicon dioxide solution of nanometer, a titanium dioxide solution of nanometer and a zirconium dioxide solution of nanometer. How to make the inorganic oxide solution of nanometer is illustrated with an example of making the silicon dioxide solution of nanometer as following.

Under a room temperature, 1000 g ethanol, 120 g de-ionized water and 80 g 25% concentration of hydrochloric acid are mixed together to form a mixture solution. Then 800 g tetraethyloxysilane is added therein to make the mixture solution react for about 3 hours. During the reaction process, the mixture solution is agitated with a magnetic stirrer. After the reaction process, the mixture solution becomes into a silicon dioxide sol, the silicon dioxide sol is stood for 15 hours to form a silicon dioxide gel with a full hydrolysis and polymerization. Then the silicon dioxide gel is diluted with an alcohol solvent according to different ratio to form the silicon dioxide solution of nanometer having different concentration.

Secondly, the inorganic oxide solution of nanometer is coated onto surfaces of the elements of the electronic product before the secondary processing of the electronic product is started, wherein the elements needs to be protected while the electronic product is processed in the secondary processing.

Lastly, the electronic product coated with the inorganic oxide solution of nanometer is subjected to the room temperature or a heating environment lower than 50 degrees centigrade to make the inorganic oxide solution of nanometer dry (namely, evaporated to be a gas phase) for forming nanometer protective films on the surfaces of the elements of the electronic product so as to protect the elements from being thermally damaged in the secondary processing of the electronic product, wherein the thickness of the nanometer protective film can be 1 micron, 5 micron, 10 micron or 15 micron and so on. The thickness of the nanometer protective film can be controlled by adjusting the concentration of the inorganic oxide solution of nanometer. Generally, the greater the concentration of the inorganic oxide solution of nanometer is, the greater the thickness of the nanometer protective film is.

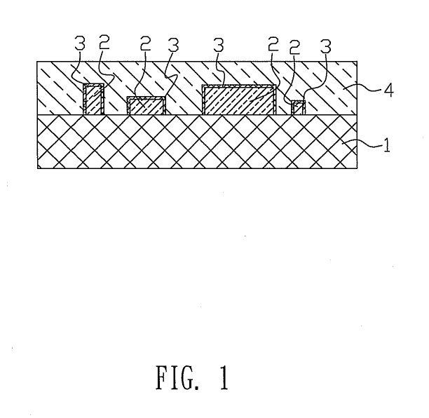

A first unlimited embodiment is described as following. Referring to FIG. 1, the electronic product made by the method of the present invention includes a substrate 1, and a plurality of elements 2 disposed on the substrate 1 and needing to be protected in the secondary processing of the electronic product. The secondary processing is operated with a metal evaporation. Each of the elements 2 is covered with a nanometer protective film 3 made of the inorganic oxide solution of nanometer. When the electronic product is further processed by the metal evaporation to form a wrapping layer 4 thereon, the nanometer protective films 3 can prevent the elements 2 from being thermally damaged during the metal evaporation because of a good adiabatic ability of the nanometer protective films 3.

A second unlimited embodiment is described as following. In the second unlimited embodiment, the electronic product includes two collateral wires. Each of the wires is wrapped with an insulating rubber and the two insulating rubbers are glued to connect with each other. The electronic product further includes a shell body which is injection molded under a high-temperature environment and connected with the insulating rubbers. When the electronic product is made by a traditional method, the high-temperature environment can make the insulating rubbers melt down and causes the two wires to short-circuit. Experiment statistics show that the probability of the two wires short-circuiting is 55%. When the electronic product is made by the method of the present invention, coat the inorganic oxide solution of nanometer onto the insulating rubbers so as to form the nanometer protective films thereon before the shell body is injection molded under the high-temperature environment, wherein the elements needing to be protected are the insulating rubbers and the secondary processing is operated with an injection molding under the high-temperature environment. During the injection molding of the shell body, the nanometer protective films can effectively seclude the insulating rubbers from the high-temperature environment so as to effectively prevent the insulating rubbers from melting down because of the good adiabatic ability of the nanometer protective films. Experiment statistics show that, the probability of the two wires short-circuiting is reduced to 12% when the thickness of the nanometer protective film is 1 micron and the probability of the two wires short-circuiting is reduced to 0% when the thickness of the nanometer protective film is 10 micron.

As described above, the method of the present invention can effectively protect the elements of the electronic product from being thermally damaged in the secondary processing of the electronic product by forming the nanometer protective films on the elements before the secondary processing of the electronic product, wherein the nanometer protective film made of the inorganic oxide solution of nanometer has the good adiabatic and insulating ability. Furthermore, the procedure of the method is relatively simple and the nanometer protective film is apt to be made so thinly that it occupies a smaller space in the electronic product.

What is claimed is:

1. A method adapted for protecting elements of an electronic product from being thermally damaged in a secondary processing of the electronic product, comprising the steps of:
firstly, making an inorganic oxide solution of nanometer by way of a sol-gel method;
secondly, coating the inorganic oxide solution of nanometer onto surfaces of the elements before the secondary processing of the electronic product; and
lastly, subjecting the electronic product coated with the inorganic oxide solution of nanometer to a room temperature or a heating environment lower than 50 degrees centigrade to make the inorganic oxide solution of nanometer dry for forming nanometer protective films on the surfaces of the elements of the electronic product so as to protect the elements from being thermally damaged in the secondary processing of the electronic product.

2. The method as claimed in claim 1, wherein the inorganic oxide solution of nanometer can be any one of a silicon dioxide solution of nanometer, a titanium dioxide solution of nanometer and a zirconium dioxide solution of nanometer.

3. The method as claimed in claim 1, wherein the inorganic oxide solution of nanometer can be a mixture of at least two selected from a silicon dioxide solution of nanometer, a titanium dioxide solution of nanometer and a zirconium dioxide solution of nanometer.

4. The method as claimed in claim 1, wherein the thickness of the nanometer protective film is 1˜15 micron.

5. The method as claimed in claim 4, wherein the thickness of the nanometer protective film is 5˜10 micron.
